(19) United States
(12) Patent Application Publication
(10) Pub. No.: US 2025/0382989 A1
(43) Pub. Date: Dec. 18, 2025

(54) TAPERED POST FOR A BALL JOINT ASSEMBLY

(71) Applicant: RB Distribution, Inc., Colmar, PA (US)

(72) Inventors: Stephen Miller, Glenside, PA (US); Steven Zdziebkowski, Drexel Hill, PA (US)

(73) Assignee: RB Distribution, Inc., Colmar, PA (US)

(21) Appl. No.: 18/742,694

(22) Filed: Jun. 13, 2024

(51) Int. Cl. F16C 11/06

(52) U.S. Cl. CPC F16C 11/0695; F16C 11/068

(57) ABSTRACT

A post and stud for a ball joint assembly includes a post with a first end, an intermediate portions and a second end. The first end is externally threaded to receive a complementary fastener and the second end is internally threaded. A threaded stud has a first end that complements the internally threaded second end of the post and the second end of the stud is threaded for a predetermined application.

### BACKGROUND

Many vehicles, including cars and trucks, use multiple components to secure the drive axle to the vehicle's frame. It is important to maintain the geometry of the vehicle's suspension over a wide range of driving conditions, which can accelerate wear on the suspension components requiring replacement of torque rod and ball joint assemblies. One of the problems encountered in making these repairs is replacing the ball joint that forms part of the ball joint assembly. In most incidences, the ball joint must be directed to a specific application so that it is compatible with the ball joint assembly and another specific component of the suspension system.

### SUMMARY OF THE INVENTION

The disclosed post and stud are static components of a flexible ball joint assembly. The post has one end that is configured to receive a complementary fastener for attaching the post in a ball joint assembly and a second end that has an internally threaded bore. The stud is threaded on both ends with one end threaded to complement the internally threaded bore in the post and the second end threaded that is selected for a specific suspension system application. As a result, the post can be used in different end applications by selecting the required stud for the application.

### BRIEF DESCRIPTION OF THE DRAWINGS

FIG. 1 is an elevation view of a post for the ball joint assembly;

FIG. 2 is a section along the line 2-2 in FIG. 1;

FIG. 3 is a perspective view of a ball joint assembly;

FIGS. 4 and 5 are sections along the line 4/5-4/5 in FIG. 3 to illustrate different stud in the post;

FIG. 6 is an exploded view of a ball joint assembly in FIG. 3;

FIG. 7 is a section view illustrating a second post configuration;

FIG. 8 is an exploded view of a ball joint assembly with the second post configuration;

FIG. 9 is a perspective view of the ball for the ball joint assembly; and,

FIG. 10 is a section along the line 10-10 in FIG. 9.

### DETAILED DESCRIPTION

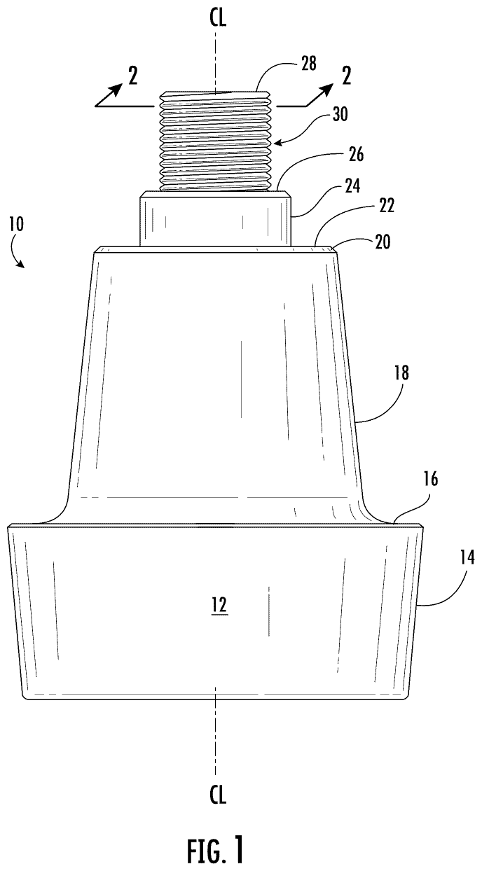

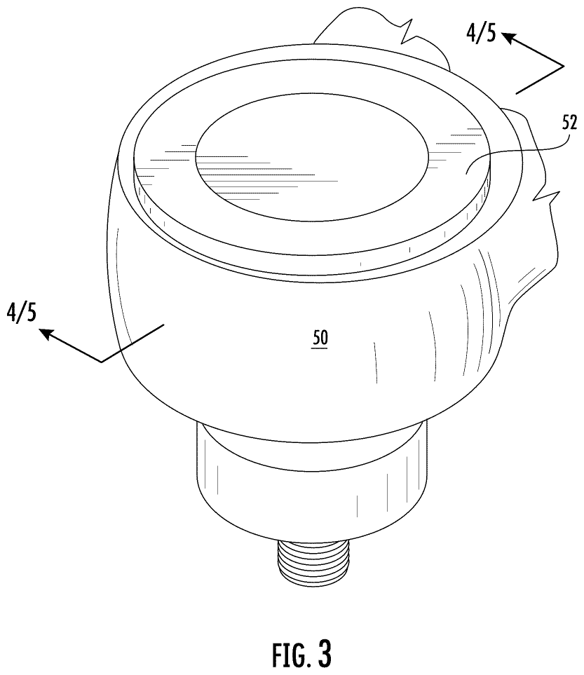

Illustrative examples of a tapered post for a ball joint assembly will be described with reference to FIGS. 1-10 wherein the same or similar elements re identified by the same numeral.

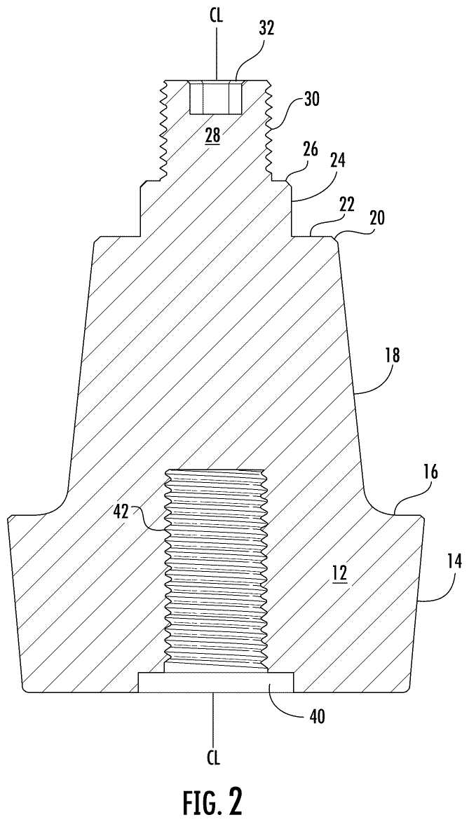

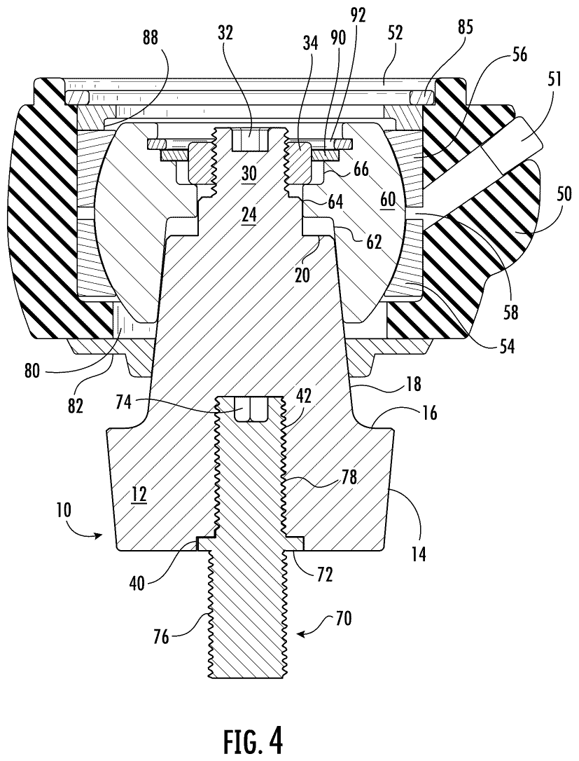

With reference to FIG. 1, the post 10 has a generally circular lower portion 12 with a first diameter and a surrounding wall 14 that flows into the base 16 which supports a tapered mid-portion 18 that has a decreasing diameter up to the shoulder 20 and plateau 22. The circular collar 24 extends from plateau 22 to the shoulder 26 which supports the externally threaded upper end 28 of the post 10. With reference to FIG. 2, it can be seen that the generally circular portion 12 has a first bore 40 that forms a collar and a second bore 42 that is internally threaded. Still with reference to FIG. 2, the externally threaded upper end 28 of the post 10 has a recess 32 that is configure to receive a tool for installing the post 10 onto a threaded stud 70, shown for example in FIG. 4. With reference to FIGS. 1 and 2, it can be seen that the above described post 10 is centered about the longitudinal axis CL.

With reference to FIG. 4, the ball joint assembly fits within the housing 50 which has a bore 51 for attaching a grease or lubrication fitting. The housing has an opening that receives the first bushing section 54, the ball 60 and the second busing section 56. The ball 60 separates the two bushing sections to define a circumferential slot 58 for lubricant entering through bore 51. The ball 60 is configured internally at 62 to receive the shoulder 20 of the post 10. The ball 60 has an inward circular projection 64 that receives the circular collar 24 and a circular recess 66 that is enlarged to receive a fastener 34 that applied to the threads 30. The locking plate 90 fits over the head of the fastener 34 and the snap ring 92 serves as a retainer for the locking plate 90. In the lower portion 12, the bore 42 has threads that complement the threads 78 on the first, upper part of the stud 70. The collar 72 fits within the bore 40 and defines a second or lower part of the stud 70 that has coarse threads 76 that are configured for a specific application of the ball in a vehicle suspension. The first, upper part of the stud 70 includes a recess 74 that is configured to receive a tool for tightening the threads 78 to the mating part of the vehicle.

With reference to FIG. 5, the illustrated configuration differs from FIG. 4 in that the stud 80 has finer threads 86 that are configured for a specific application of the ball in a vehicle suspension. Accordingly, the same post 10 is usable in the configurations illustrated in both FIG. 4 and FIG. 5.

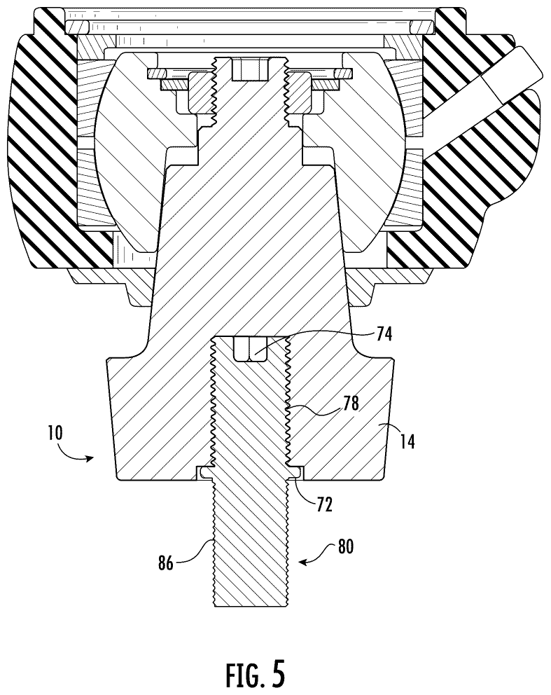

The ball joint assembly will be set forth in detail with reference to the exploded view in FIG. 6. The post 10 is assembled in the housing 50, which is associated with a given suspension component. The dust cover 82 fits between the post 10 and the lower surface of the housing 50 and encloses the gap 80. The rubber bushing pad 102 is inserted in the housing 50. The bushing halves 54 and 56 and the ball 60 are inserted in the housing 50. The nut 34, locking plate 90 and snap ring 92 are assembled as described in connection with FIGS. 4 and 5. The assembled positions of the second retainer 104, second snap ring 106, and top cover 108 are also described in connection with FIGS. 4 and 5. Preferably, the bushing halves 54, 56 and the ball 60 are retained in the housing 50 via the second retainer 104 and second snap ring 106 prior to the post 10 being inserted into the ball 60. The grease fitting 51 is inserted in bore 51.

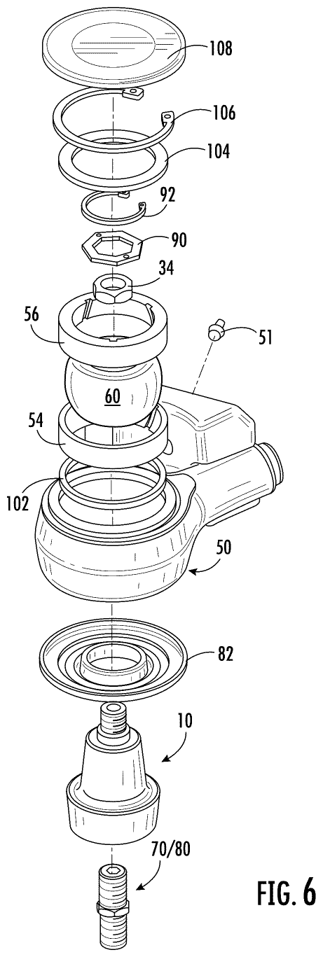

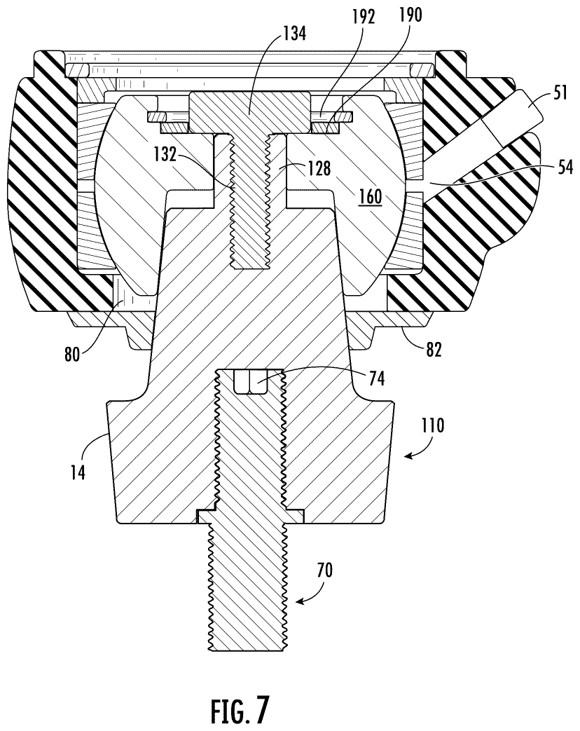

FIGS. 7 and 8 detail an alternative configuration, which has many of the previously described elements. In this configuration, the post 110 has a different fastener arrangement. The upper end 128 of the post 110 is internally threaded at 132 to receive a threaded bolt fastener 134. As described with the prior configuration, the bolt 134 fixes the post 110 in the ball 160. The locking plate 190 and the snap ring 192 are configured to complement the bolt 134. As shown in FIG. 8, the assembly of the post 110 is follows the same order as the previous configuration and uses the alternative fastener 134.

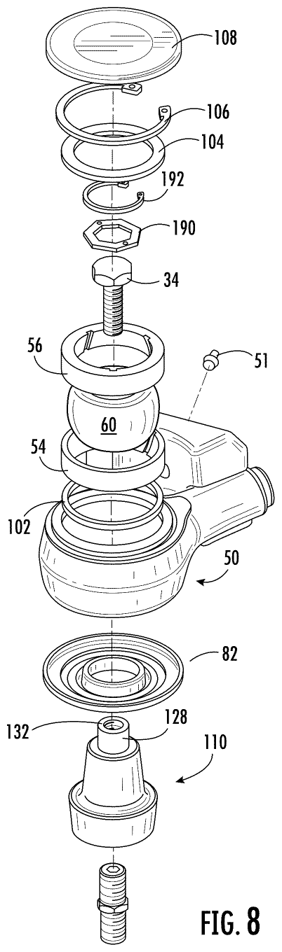

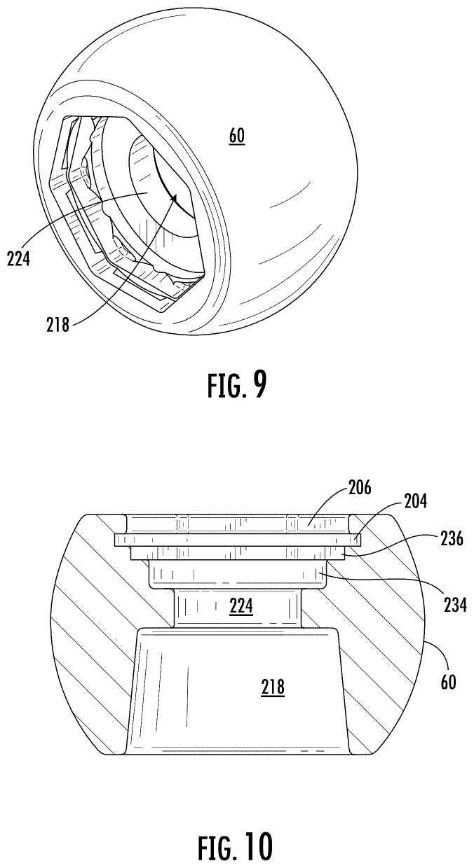

The configuration of the ball 60 will be described with reference to FIGS. 9 and 10. The ball 60 has a first end with recesses 218 and 224 to receive the tapered mid-portion 18 (in FIG. 4) and the circular collar 24 of the post 10. The second end of the ball 60 has recesses 204, 206, 236 and 234 that are configured to receive and retain the fastener, either 34 or 134, the locking plate 90, and the snap ring 92 associated with the fastener.

What is claimed is:

1. A post and stud for a ball joint assembly, the post and stud comprising:
a post having a first end configured to receive a complementary fastener that attaches the post in a ball joint assembly and a second end that has a threaded bore; and,
a threaded stud that has a first threaded portion that complements the threaded bore in the second end of the post and a second threaded portion selected for a predetermined application of a ball joint assembly.

2. The post and stud of claim 1, wherein the first end of the post has external threads.

3. The post and stud of claim 2, wherein the first end of the post has a tool receiving bore.

4. The post and stud of claim 3, wherein the external threads and the tool receiving bore are on a common centerline.

5. The post and stud of claim 2, wherein the external threads are formed on a projecting portion of the post.

6. The post and stud of claim 1, wherein the first end configured to receive a complementary fastener and the second end that has a threaded bore are separated by a solid portion of the post.

7. The post and stud of claim 1, wherein the first end has an internally threaded bore configured to receive a fastener.

8. The post and stud of claim 7, wherein the threaded bore in the first end and the threaded bore of the second end are separated by a solid portion of the post.

9. The post and stud of claim 1, wherein the post has a tapered exterior.

10. The post and stud of claim 5, wherein the tapered exterior of the post tapers toward a centerline extending between the first end and the second end.

11. A post and stud for a ball joint assembly, the post and stud comprising:
a body having a first end portion with a first diameter, an intermediate portion that extends between the first end portion and a second end portion and has a second diameter that is greater than the first diameter,
wherein the first end portion is externally threaded to receive a complementary fastener and the second end portion has an internally threaded bore; and,
a threaded stud with a first end that is externally threaded to complement the internally threaded bore and a second end that is externally threaded for a predetermined application.

12. The post and stud of claim 11, wherein the second end portion has a recess around the internally threaded bore and the threaded stud has a shoulder that abuts the recess and limits the threaded stud's travel into the internally threaded bore.

13. The post and stud of claim 11, wherein the first end and the second end of the threaded stud have a common thread pattern.

14. The post and stud of claim 12, wherein the stud has different thread patterns on the first end and the second end and a shoulder separates the thread patterns.

15. The post and stud of claim 12, wherein the shoulder limits the threaded stud's travel into the internally threaded bore.

16. The post and stud of claim 11, wherein the first end portion is a projection from the intermediate portion.

17. The post and stud of claim 11, wherein the first end portion of the post has a tool receiving bore.

18. The post and stud of claim 11, wherein the stud has a tool receiving bore.

19. The post and stud of claim 11, wherein the first end portion of the post has a tool receiving bore and the second end of the stud has a tool receiving bore.

20. A kit for a ball joint assembly comprising:
a housing with a central through aperture;
a ball that is dimensioned to fit within the through aperture and has a central opening;
a bushing disposed between the ball and the housing defining the through aperture and permits movement of the ball;
a post that has a body with a first portion dimensioned to be received in the central opening and a second portion that extends beyond the housing; the first portion dimensioned to be received in the central opening has a threaded projection; the second portion that extends beyond the housing has a threaded bore; and,
a stud with a first portion that is threaded to complement the threaded bore and a second portion that is threaded for a predetermined application.

21. The kit of claim 20, wherein the threaded projection has a tool receiving bore.

22. The kit of claim 20, wherein the stud has a tool receiving bore.

23. The kit of claim 20, wherein the housing and the bushing have a through passage for lubrication.

24. The kit of claim 20, wherein the ball has inward protrusions that limit ingress of the first portion of the post into the central opening of the ball.

25. The kit of claim 20, wherein the bushing is metallic.

26. The kit of claim 20, wherein a threaded fastener is connected to the threaded projection of the first portion and a locking plate and retaining ring lock the threaded fastener in place.

27. A post for a ball joint assembly, the post comprising:
a tapered body having an externally threaded projection at a first end and an internally threaded bore at a second end that is on a common centerline with the externally threaded projection.

28. The post of claim 27, wherein the threaded projection has an internal recess configured to receive a tool.

29. The post of claim 28, wherein the body has a first diameter at the externally threaded project and a second larger diameter at the second end.

30. The post of claim 27, wherein the body has a first diameter at the threaded project, a second larger diameter at the second end, an intermediate portion of the body has a third diameter that is greater than the first diameter and less than the second diameter, and a portion of the body between the intermediate portion and the projection has a fourth diameter that is greater than the first diameter and less than third diameter.
